(19) United States
(12) Patent Application Publication
(10) Pub. No.: US 2026/0230806 A1
(43) Pub. Date: Aug. 6, 2026

(54) TECHNIQUES FOR ON-DEVICE SIM ACTIVATION

(71) Applicant: Apple Inc., Cupertino, CA (US)

(72) Inventors: Raj S. CHAUGULE, Santa Clara, CA (US); Avinash NARASIMHAN, Fremont, CA (US); Deepak S. MURALIDHARAN, Fremont, CA (US); He ZHENG, Irvine, CA (US); Sherman X. JIN, Santa Clara, CA (US)

(21) Appl. No.: 19/446,505

(22) Filed: Jan. 12, 2026

Related U.S. Application Data
(60) Provisional application No. 63/753,796, filed on Feb. 4, 2025.

(51) Int. Cl. H04W 8/26; H04W 8/20; H04W 12/06

(52) U.S. Cl. CPC H04W 8/265; H04W 8/20; H04W 12/06

(57) ABSTRACT

The described embodiments relate to on-device activation of a subscriber identity module (SIM) at a wireless device with user authentication in accordance with requirements for cellular service activation of a mobile network operator (MNO) associated with the SIM. Provisioning of the SIM to the wireless device can occur in association with a device activation procedure or delayed until later. Device software can direct the wireless device to a carrier authentication end-point for secure user authentication to install and activate a SIM on the wireless device. Activation of the SIM occurs directly on the wireless device without requiring in-person interaction at a retail sales location. A device services (DS) server communicates directly with back-end systems of one or more MNOs, where the DS server acts as a proxy for the MNOs to communicate with wireless devices.

### CROSS-REFERENCE TO RELATED APPLICATIONS

The present application claims the benefit of U.S. Provisional Application No. 63/753,796, entitled “TECHNIQUES FOR ON-DEVICE SIM ACTIVATION,” filed February 4, 2025, the content of which is incorporated by reference herein in its entirety for all purposes.

### FIELD

The described embodiments relate to wireless communications, including methods and apparatus for on-device activation of a subscriber identity module (SIM) at a wireless device with user authentication in accordance with requirements for cellular service activation of a mobile network operator (MNO) associated with the SIM.

### BACKGROUND

Newer generation, fifth generation (5G), cellular wireless networks that implement one or more 3^{rd} Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Typically, wireless devices have been configured to use removable UICCs, that include at least a microprocessor and a read-only memory (ROM), where the ROM is configured to store an MNO profile, also referred to as subscriber identity module (SIM) or SIM profile, which the wireless device can use to register and interact with an MNO to obtain wireless services via a cellular wireless network. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs or integrated with other system components as iUICCs, which can provide advantages over traditional, removable UICCs. The eUICCs and/or iUICCs can include a rewritable memory that can facilitate installation, modification, and/or deletion of one or more electronic SIMs (eSIMs) on the eUICC/iUICC, where the eSIMs can provide for new and/or different services and/or updates for accessing extended features provided by MNOs. An eUICC/iUICC can store a number of MNO profiles—also referred to herein as eSIMs—and can eliminate the need to include UICC-receiving bays in wireless devices. The use of multiple SIMs and/or eSIMs is expected to offer flexibility for access to multiple services of multiple wireless networks.

A wireless device obtain an eSIM profile from an MNO provisioning server where notification regarding availability of the eSIM profile can be provided via a devices services server. Present cellular wireless network architectures do not support direct communication between the devices services server and back-end systems of various MNOs. Protocols for eSIM profile activation and user authentication via a new interface between the devices services server and MNO back-end systems are required.

### SUMMARY

The described embodiments relate to wireless communications, including methods and apparatus for on-device activation of a subscriber identity module (SIM) with user authentication in accordance with requirements for cellular service activation of a mobile network operator (MNO) associated with the SIM. Provisioning of the SIM to the wireless device can occur in association with a device activation procedure or delayed until later. Device software can direct the wireless device to a carrier authentication end-point for secure user authentication to install and activate a SIM on the wireless device. In some embodiments, transfer of cellular service from a SIM of another wireless device to the wireless device can include SIM activation at the wireless device before SIM deactivation at the other wireless device. In some embodiments, activation of the SIM can occur subsequent to device activation, e.g., after an out-of-box setup procedure. In some embodiments, provisioning and activation procedures specific to a carrier are provided with carrier-specified user authentication procedures. Activation of the SIM occurs directly on the wireless device without requiring in-person interaction at a retail sales location. A device services (DS) server communicates directly with back-end systems of one or more MNOs, also referred to as carriers. The DS server acts as a proxy for the carriers for communicating with wireless devices. User credentials are encrypted locally on the wireless device and communicated securely to MNO back-end systems via the DS server. An MNO back-end system can implement various application programming interfaces (APIs) that communicate information required for user authentication and to assist with SIM provisioning to and SIM activation at the wireless device. In some embodiments, a SIM activation procedure in association with an out-of-box setup procedure can include use of a submit order message that specifies, by the MNO back-end system to the DS server, an order for a wireless device and associated SIM including specific parameter values of the wireless device and user authentication information required by the carrier. The SIM activation procedure can further include use of authenticate user request and response messages that provide credentials for user authentication between the DS server and the MNO back-end system. The SIM activation procedure can further include use of a complete order message, from the DS server to the MNO back-end system, to indicate successful installation and activation of the SIM on the wireless device. In some embodiments, the SIM activation procedure can include a cancel order message from the MNO back-end system to the DS server to vacate a previous submit order message for a wireless device. In some embodiments, a SIM activation procedure for installation and activation of a SIM to a wireless device after completion of an out-of-box setup procedure can include use of the submit order message, from an MNO back-end system to a DS server, to specify information regarding a SIM for a particular wireless device and user authentication information required by the carrier for SIM installation and/or activation to occur at the wireless device. In some embodiments, a carrier-managed device setup procedure can include the submit order message, from an MNO back-end system to a DS server, specify information regarding a SIM for a particular wireless device, one or more identifiers of the wireless device, and a resolvable network address, e.g., a uniform record locator (URL), for a carrier-managed server with which the wireless device can implement the carrier-managed device setup procedure.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to adapt communication parameters for a wireless device, according to some embodiments.

FIG. 2 illustrates a block diagram of a more detailed view of exemplary components of a wireless device of the system of FIG. 1, according to some embodiments.

FIG. 3A illustrates a block diagram of an exemplary system for remote profile management (RPM) of electronic subscriber identity module (eSIM) profiles of a wireless device, according to some embodiments.

FIG. 3B illustrates a block diagram of an exemplary original equipment manufacturer (OEM) system for verification of a wireless device, according to some embodiments.

FIG. 3C illustrates a flow diagram of an example of real-time subscriber identity module (SIM) activation for a wireless device, according to some embodiments.

FIG. 3D illustrates a flow diagram of an example of delayed SIM activation for a wireless device, according to some embodiments.

FIGS. 4A, 4B, and 4C illustrate flow diagrams of an example of an on-device SIM activation procedure in association with an out-of-box device activation process, according to some embodiments.

FIGS. 5A and 5B illustrate flow diagrams of an example of an on-device SIM activation procedure performed after completion of an out-of-box device activation process, according to some embodiments.

FIG. 6 illustrates a flow diagram of an example of an on-device SIM activation procedure performed in association with a carrier-managed process, according to some embodiments.

FIG. 7 illustrates a flow chart of an exemplary method to manage on-device SIM activation for a wireless device by a device services server, according to some embodiments.

FIG. 8 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

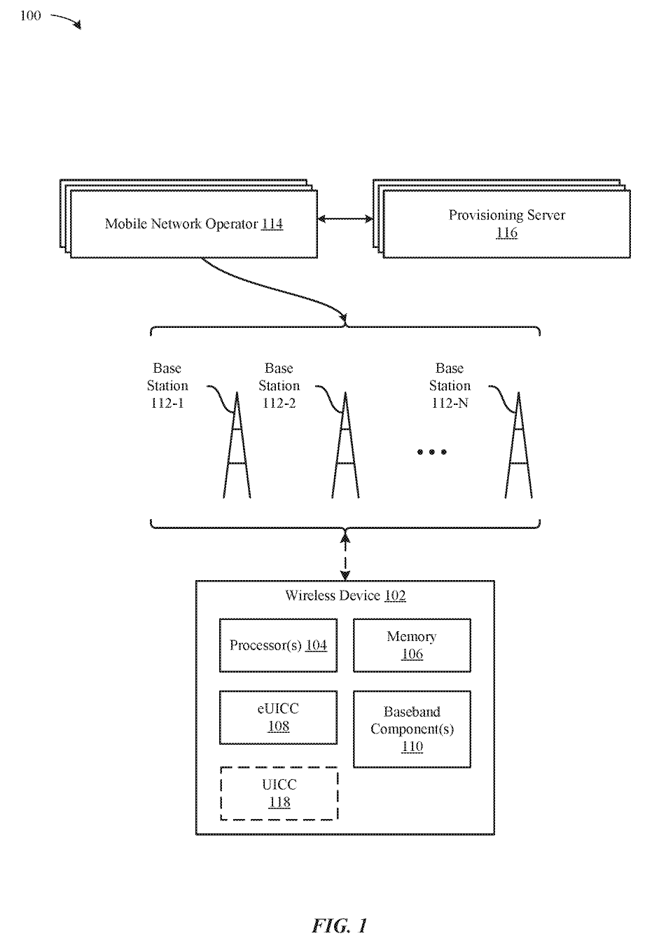

These and other embodiments are discussed below with reference to FIGS. 1 through 8; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. MNOs 114 can also be referred to as carriers herein, which can include mobile virtual network operators (MVNOs) that lease access to cellular wireless networks built and managed by another MNO. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIMs for accessing services offered by one or more different MNOs 114 via communication through base stations 112-1 to 112-N. To be able to access services provided by the MNOs, one or more eSIMs can be provisioned to the eUICC 108 of the wireless device 102. The wireless device 102 can include wireless circuitry, including the baseband component 110 and at least one transmitter/receiver, also referred to as a transceiver to transmit to and receive cellular wireless signals from network access network entities of a cellular wireless network. In some embodiments, the provisioning server 116 can provide an indication to the wireless device 102 via a device services (DS) server of availability of an eSIM to download to the wireless device 102. In some embodiments, the DS server communicates using one or more application programming interface (API) messages to allow for on-device SIM (e.g., eSIM) activation, which can be in association with or subsequent to a device activation process for setup of the wireless device 102.

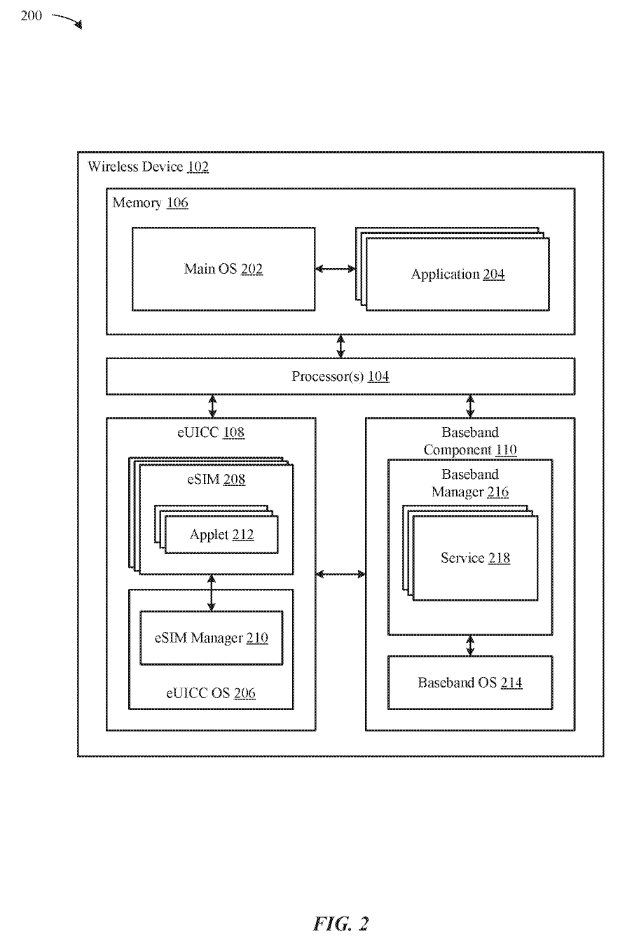

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM data) from the provisioning server 116 for purposes of managing eSIMs 208. The baseband manager 216 can be configured to implement services 218, which represent a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108. In some embodiments, a processor 104 of the wireless device 102 and/or the eUICC 108 can include a local profile assistance (LPA) module to assist with management of eSIMs on the eUICC 108 of the wireless device 102.

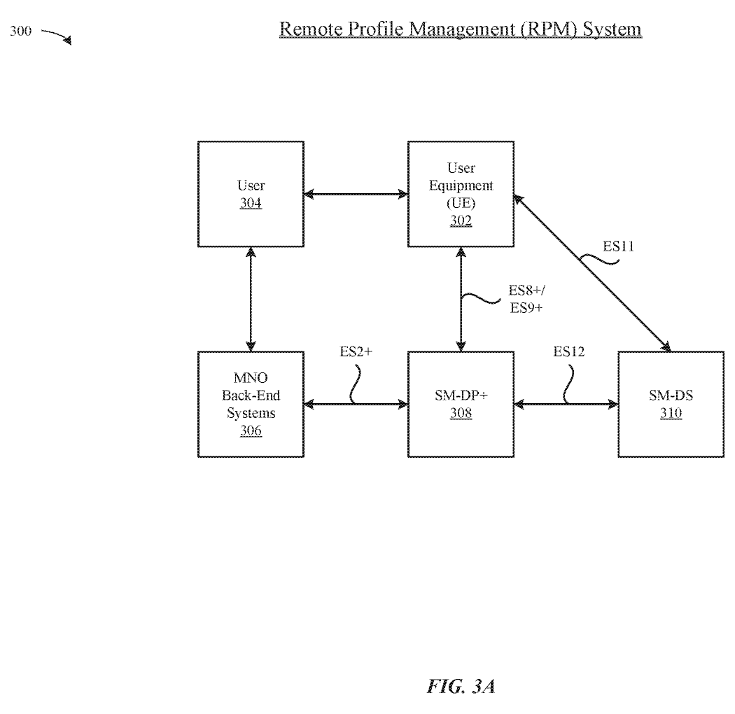

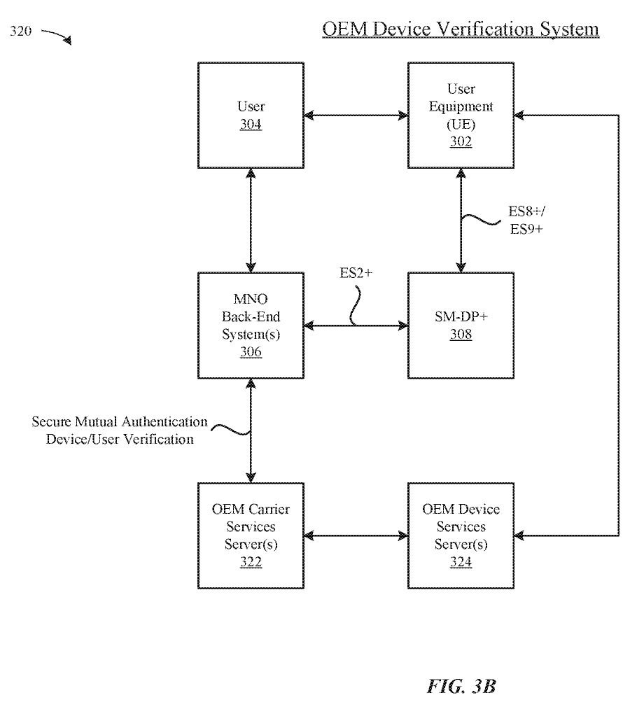

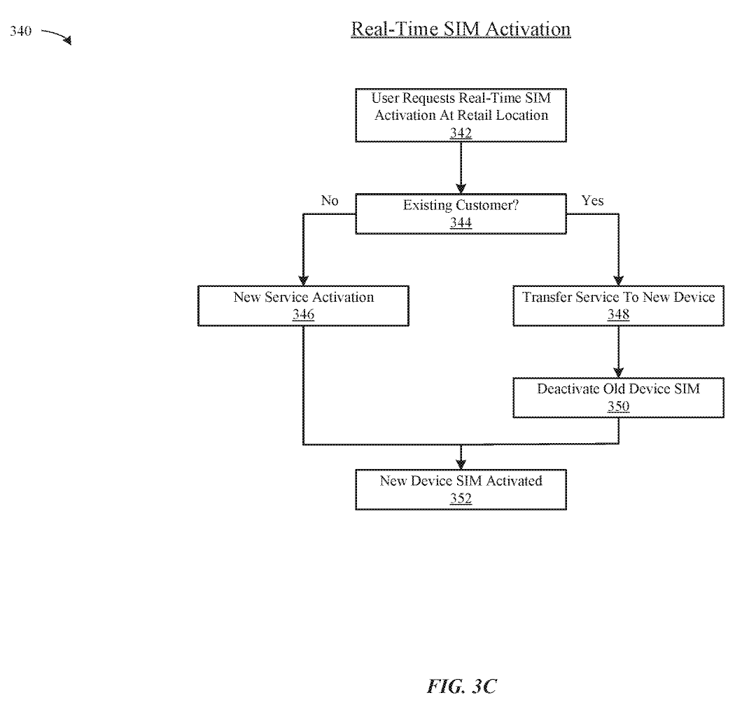

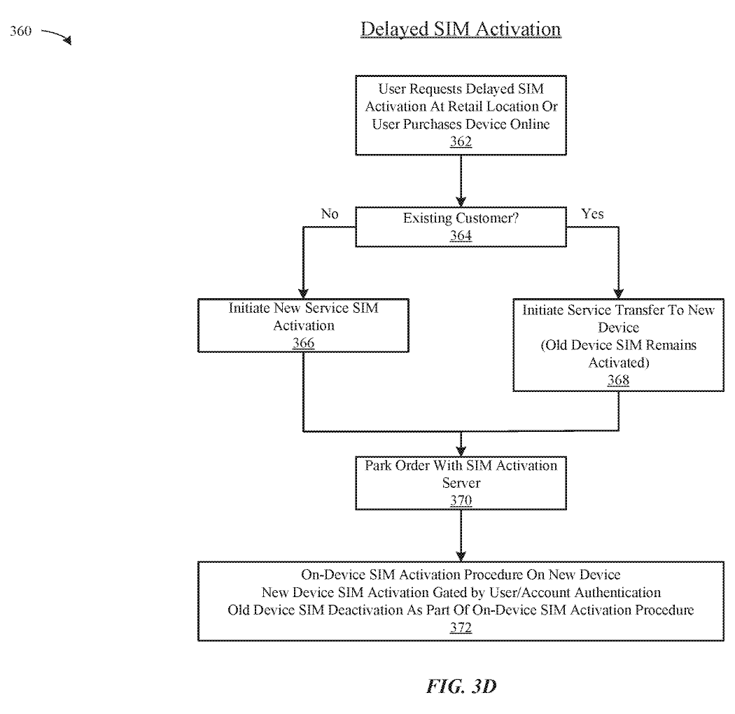

FIG. 3A illustrates a block diagram 300 of an exemplary system for providing remote profile management (RPM) of one or more eSIMs 208 stored on an eUICC 108 of a user equipment (UE) 302. A user 304 of the UE 302 can interact with MNO back-end systems 306 associated with an MNO 114 to obtain and/or manage an eSIM 208 for the UE 302, e.g., to subscribe to and/or modify cellular wireless service provided by the MNO 114 via credentials of the eSIM 208. The MNO back-end systems 306 can communicate via an ES2+ interface with an MNO provisioning server 116, e.g., a subscription manager data preparation plus (SM-DP+) server 308, to order preparation of an eSIM 208, provide an update to an eSIM 208 for the UE 302, and/or provide other eSIM 208 administrative functions. The SM-DP+ 308 can be connected via an ES12 interface to a subscription manager - discovery server (SM-DS) 310 that can be accessed by the UE 302 via an ES11 interface. The SM-DP+ 308 can communicated via the ES12 interface to register event records for the UE 302 at the SM-DS 310. The SM-DP+ 308 can also delete event records for the UE 302 at the SM-DS 310 via messages over the ES12 interface. The SM-DS 310 can aggregate eSIM profile events for the UE 302 for one or more MNOs 114 and provide notification to the UE 302, via the ES11 interface, of availability of one or more eSIM profile events for the eUICC 108 of the UE 302, e.g., via a push notification message to the UE 302, responsive to a pull notification message from the UE 302, where notification can occur periodically at regular intervals and/or manually on demand. The SM-DS 310 can provide information over the ES11 interface via notification messages to the UE 302 regarding an eSIM 208 available to download to the eUICC 108 of the UE 302 and/or an eSIM RPM procedure to be executed for an eSIM 208 on the eUICC 108 of the UE 302. The eUICC 108 of the UE 302 can communicate with the SM-DP+ 308 via an ES8+ interface to manage download an installation of an eSIM 208 profile from the SM-DP+ 308 to the eUICC 108 of the UE 302. An LPA of the UE 302 can also communicate with the SM-DP+ 308 via an ES9+ interface to provide secure transport and management of a bound profile package (BPP) that securely contains an eSIM 208 and/or to provide for RPM procedures for one or more eSIM 208 on the eUICC 108 of the UE 302. Notably, in the RPM system of FIG. 3A, there is no direct standardized connection between the MNO back-end systems 306 and the SM-DS 310.

FIG. 3B illustrates a block diagram 320 of an exemplary device/user verification system that can be implemented with a mixture of standardized and proprietary interfaces and communication messaging by an original equipment manufacturer (OEM) of the UE 302. One or more MNO back-end systems 306 of one or more carriers (e.g., MNOs, MVNOs) can communicate with one or more OEM carrier services servers 322 to provide a secure interface for device verification and/or user authentication. Connection between an MNO back-end system 306 and an OEM carrier service server 322 can be established with mutual secure socket layer (SSL) authentication of each side using verifiable certificates to ensure that each side can trust the identity of the opposite side. The MNO back-end system 306 can send a validation request message to the OEM carrier services server 322 to obtain (and/or validate) information regarding a UE 302, e.g., a type of device (smart phone, tablet computer, wearable, etc.). In some embodiments, a response to the validation request message is provided only when a SIM (eSIM 208) can be provided to the UE 302. The UE 302 can be specified by a unique hardware identifier, such as an eUICC identifier (EID) value that is uniquely associated with an eUICC 108 of the UE 302, and the MNO back-end system 306 can request to validate the unique hardware identifier, e.g., the EID value, of the UE 302. The OEM carrier services server 322 can respond to the MNO back-end system 306 with a validation response message that includes information regarding the UE 302, such as one or more unique hardware identifier values for the UE 302, e.g., international mobile equipment identifier (IMEI) values, the EID value, and a state of a SIM (e.g., an eSIM 208) associated with the UE 302, where the SIM (eSIM 208) is specified by an integrated circuit card identifier (ICCID) value. The OEM carrier services server(s) 322 can communicate with one or more OEM device services servers 324 that communicate directly with and assist with management of the UE 302. Additional connections illustrated in FIG. 3B include wireless communication standardized interfaces, such as an ES2+ interface between MNO back-end systems 306 and MNO provisioning servers, e.g., SM-DP+ 308, and an ES8+/E9+ interface between the MNO provisioning server, e.g., SM-DP+ 308, and the UE 302. A user of the UE 302 can directly interface with each of the UE 302 and the MNO back-end systems 306.

FIG. 3C illustrates a flow diagram 340 of an example of real-time SIM activation for a new wireless device 102. At 342, a user 304 requests real-time activation of a SIM (e.g., an eSIM 208) while at a retail sales location, e.g., managed by a carrier or by an OEM of the wireless device 102. At 344, an MNO back-end system 306 and/or an OEM device services server 324 can provide information to determine whether the user 304 is known to the carrier, e.g., has an active subscription to cellular wireless service with the carrier. For a user 304 that is a new customer for the carrier, at 346, a new cellular service activation procedure can be performed. For a user 304 that is an existing customer for the carrier and seeks to transfer cellular wireless service from a previous/old wireless device 102 to the new wireless device 102, at 348, a cellular wireless service transfer process can occur, e.g., from a SIM/eSIM of the previous/old wireless device 102 to an eSIM 208 of the new wireless device 102. At 350, after transfer of the cellular wireless service from the previous/old wireless device 102 to the new wireless device 102, at 350, the SIM/eSIM of the previous/old wireless device 102 can be deactivated. Finally, at 352, the SIM (e.g., eSIM 208) of the new wireless device 102 can be activated.

FIG. 3D illustrates a flow diagram 360 of an example of delayed SIM activation for a new wireless device 102. At 362, a user 304 requests delayed activation of a SIM (e.g., an eSIM 208) while purchasing a new wireless device 102 at a retail sales location, e.g., managed by a carrier or bay an OEM of the wireless device 102, or as part of an online sales order for the new wireless device 102 (e.g., opt for activation later). At 364, an MNO back-end system 306 and/or an OEM device services server 324 can provide information to determine whether the user 304 is known to the carrier, e.g., has an active subscription to cellular wireless service with the carrier. For a user 304 that is a new customer for the carrier, at 366, a new cellular service activation procedure can be initiated. For a user 304 that is an existing customer for the carrier and seeks to transfer cellular wireless service from a previous/old wireless device 102 to the new wireless device 102, at 368, a cellular wireless service transfer process can be initiated (but not completed), e.g., from a SIM/eSIM of the previous/old wireless device 102 to an eSIM 208 of the new wireless device 102. The SIM/eSIM of the previous/old wireless device 102 can remain activated. At 370, a park order with a SIM activation server can be placed to indicate that activation of the eSIM 208 of the new wireless device 102 is ready but not yet completed. At 372, an on-device SIM activation procedure can occur, where activation of the eSIM 208 of the new wireless device 102 can require authentication of a user associated with a cellular wireless service account associated with the eSIM 208 to be activated. Deactivation of the SIM/eSIM of the previous/old wireless device 102 can be performed as part of the on-device activation procedure for the eSIM 208 of the new wireless device 102.

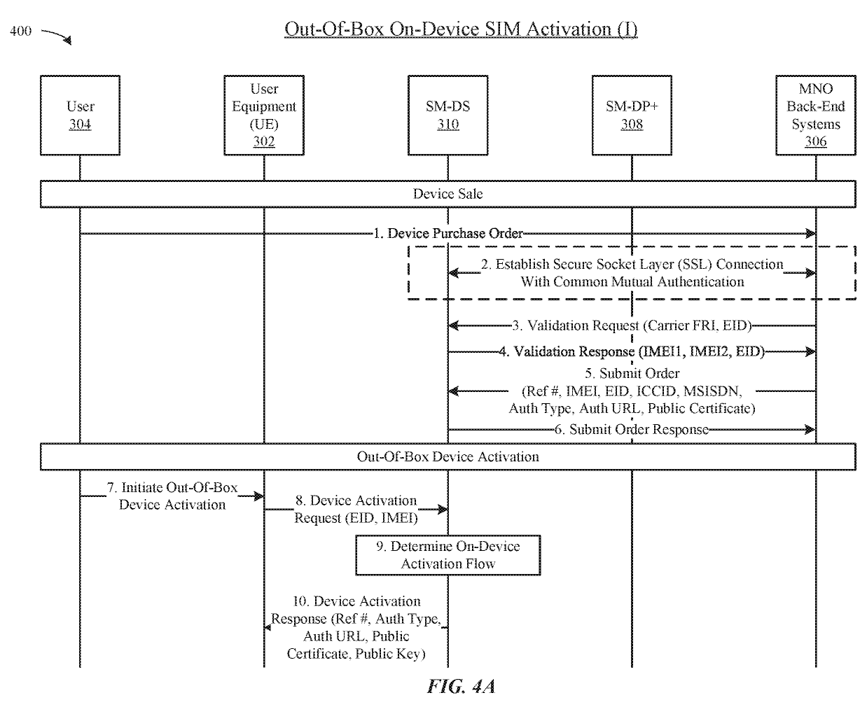

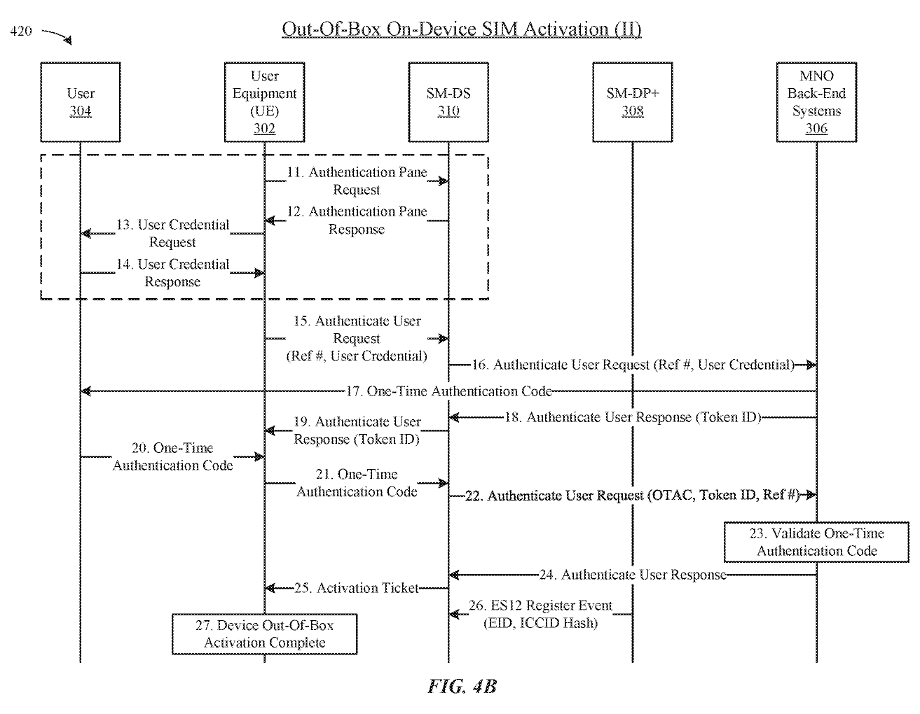

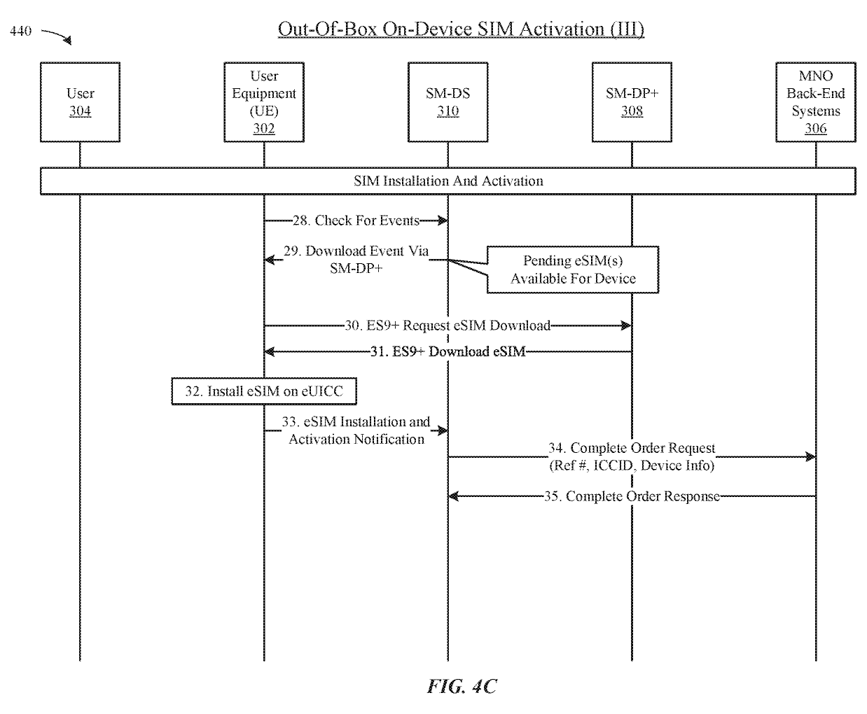

FIGS. 4A and 4B, and 4C illustrate flow diagrams 400, 420, 440 of an on-device SIM activation procedure in associated with an out-of-box device activation process. The on-device SIM activation procedure can be divided into three distinct sections, an initial sales process for acquisition of the UE 302, a subsequent out-of-box device activation process to setup the UE 302, and finally a SIM (e.g., eSIM) download, installation, and activation procedure. The on-device SIM activation procedure illustrated in FIGS. 4A and 4B, and 4C can include communication directly between a device services server, e.g., a subscription management – discovery server (SM-DS) 310 and an MNO back-end system 306. In some embodiments, communication between the SM-DS 310 and the MNO back-end system 306 includes one or more API messages defined for assisting with SIM provisioning and on-device SIM activation. At step 1, a user 304 submits a purchase order for the UE 302, e.g., via an online service. At step 2, optionally if not already existent, the SM-DS 310 establishes a secure socket layer (SSL) connection using common mutual authentication with the MNO back-end system 306. At step 3, the MNO back-end system 306 can submit a validation request message to the SM-DS 310 inquiring for information regarding the UE 302, which can be specified by a unique hardware identifier value, e.g., an EID value for an eUICC 108 of the UE 302. The validation request message can also include a function requester ID (FRI) value that can be used to identify traffic permitted to use the SM-DS 310. The validation request message can be used to obtain (and/or validate) information regarding the UE 302, e.g., a type of device (smart phone, tablet computer, wearable, etc.). In some embodiments, a response to the validation request message is provided only when a SIM (eSIM 208) can be provided to the UE 302. At step 4, the SM-DS 310 responds to the MNO back-end system 306 with a validation response message that includes information about the UE 302, such as one or more IMEI values and an EID value. At step 5, the MNO back-end system 306 sends to the SM-DS 310 a submit order message that specifies the initial order and sale of the UE 302, where the submit order message includes: i) information regarding an associated SIM (e.g., an eSIM 208 readied for the UE 302), ii) specific parameter values of the UE 302 and iii) user authentication information required by the carrier. The submit order message can include a reference number value to refer to the order for the UE 302. The submit order message can further include one or more unique hardware-based identifier values for the UE 302, e.g., an IMEI value, an EID value. The submit order message can further include unique values for the eSIM 208, e.g., an ICCID value and a mobile station international subscriber directory number (MSISDN) value, also referred to commonly as a mobile phone number. The submit order message can further include an indication of a type of user authentication required for activation of the eSIM 208. In some embodiments, the submit order message includes a resolvable network address, e.g., a uniform resource locator (URL) value, for a server with which to perform one or more authentication procedures for activation of the eSIM 208. In some embodiments, the submit order message includes a copy of a public key certificate. At step 6, the SM-DS 310 responds to the MNO back-end system 306 with a submit order response message acknowledging receipt of the submit order message.

At step 7, a user 304 initiates an out-of-box device activation procedure to setup the UE 302. At step 8, as part of the out-of-box device activation procedure, the UE 302 sends a device activation request message to a device services server, e.g., to the SM-DS 310, where the request includes one or more unique hardware-based identifier values for the UE 302, e.g., an EID value for the eUICC 108 of the UE 302 and/or an IMEI value for the UE 302. At step 9, the SM-DS 310 determines that an on-device activation flow for activation of an eSIM 208 for the UE 302 will occur. Determination for the on-device activation flow can be based at least in part on information obtained in the submit order message from the MNO back-end system 306. At step 10, the SM-DS 310 responds to the UE 302 with a device activation response message that can include at least part of the information obtained from the MNO back-end system 306 in the submit order message, e.g., one or more of: i) the reference number value for the device order, ii) user authentication information required by the carrier, e.g., an indication of a type of user authentication required by the carrier, iii) a resolvable network address, e.g., a uniform resource locator (URL) value, for a server with which to perform one or more authentication procedures for activation of the eSIM 208, iv) a public key certificate to use for messaging verification, and v) a public key to use for encryption of one or more messages or portions thereof.

Continuing with the flow diagram 420 of FIG. 4B, in some embodiments, the UE 302 can perform a user authentication procedure. At step 11, the UE 302 can submit to the SM-DS 310 a request for presentation of an authentication pane, e.g., via an interface of the UE 302. At step 12, the SM-DS 310 can provide to the UE a response regarding the authentication pane request. At step 13, the UE 302 can request from the user 304 a user credential to use for authentication of the user 304 of the UE 302. At step 14, the user 304 can respond by providing a user credential to the UE 302. In some embodiments, the user credential is pre-stored on the UE 302 (or otherwise available to the UE 302) and does not require interaction with the user 304. At step 15, the UE 302 sends to the SM-DS 310 a request to authenticate a user 304 of the UE 302, where the request can include the reference number of the order of the UE 302 and a user credential. At step 16, the SM-DS 310 sends a request for user authentication to the MNO back-end system 306, where the request can include the reference number of the order of the UE 302 and the user credential obtained from UE 302. At step 17, responsive to the authenticate user request from the SM-DS 310, the MNO back-end system 306 can send to the user 304, via a separate communication channel a one-time (ephemeral) authentication code to use to verify intention and authority of the user 304 to install and activate the eSIM 208 for the UE 302. In some embodiments, the one-time (ephemeral) authentication code can be communicated via a short message service (SMS) text message to a separate wireless device 102 of the user 304. In some embodiments, the one-time (ephemeral) authentication code can be generated at a wireless device 102 of the user 304, e.g., via a special application or user interface to an MNO system. Use of the one-time (ephemeral) authentication code for user authentication as part of the SIM activation procedure provides protection against inadvertent errors by the user 304 (e.g., an incorrect identifier value for the UE 302 entered by the user 304) and/or from malicious third-party actors that seek install malware or steal information from the UE 302, where the malicious third-party actors will not have access to the one-time (ephemeral) authentication code.. At step 18, also responsive to the authenticate user request from the SM-DS 310, the MNO back-end system 306 can send to the SM-DS 310 an authenticate user response message that includes a unique token identifier (ID). At step 19, the SM-DS 310 can respond to the UE 302 with an authenticate user response message that includes the unique token ID. At step 20, the user 304 provides to the UE 302 the one-time (ephemeral) authentication code obtained by the separate (out-of-band) communication channel from the MNO back-end system 306. At step 21, the UE 302 provides to the SM-DS 310 the one-time (ephemeral) authentication code. At step 22, the SM-DS 310 provides a second authenticate user request message to the MNO back-end system 306, the second authenticate user request message including the one-time authentication code obtained from the UE 302 along with the token ID and the reference number of the order of the UE 302. At step 23, MNO back-end system 306 validates the one-time authentication code received from the SM-DS 310 against the one-time authentication code sent to the user 304 previously. Upon successful user authentication, the MNO back-end system 306, at step 24, provides to the SM-DS 310 an authenticate user response message indicating successful user authentication. Response to successful user authentication, the SM-DS 310, at step 25, sends to the UE 302 an activation ticket associated with the eSIM 208 to be downloaded, installed, and activated at the UE 302. At step 26, an MNO provisioning server, e.g., the SM-DP+ 308, sends an register event message via an ES12 interface to the SM-DS 310, the register event message including an encrypted version of a unique identifier of the eSIM 208 for the UE 302 and a unique hardware-based identifier of the UE 302, e.g., a hash of the ICCID value of the eSIM 208 and the EID value of the eUICC 108 of the UE 302. At step 27, the out-of-box activation procedure for setup of the UE 302 completes.

Continuing with the flow diagram 440 of FIG. 4C, the UE 302 performs an on-device SIM installation and activation procedure. At step 28, the UE 302 sends a message to the SM-DS 310 to determine whether there are pending events queued for the UE 302. At step 29, the SM-DS 310 responds to the query from the UE 302 with an indication of a download event for the UE 302 to obtain one or more pending eSIMs 208 from the SM-DP+ 308. Registration of the download event occurred at step 26 after user authentication was successfully completed. At step 30, the UE 302 establishes a secure connection with the SM-DP+ 308 and requests, via an ES9+ interface, to download the eSIM 208 pending for the UE 302. At step 31, the SM-DP+ 308 downloads to the UE 302 the pending eSIM 208. At step 32, the UE 302 installs the eSIM 208 on the eUICC 108 of the UE 302. At step 33, the UE 302 provides a notification message to the SM-DS 310 of successful installation and activation of the eSIM 208 on the eUICC 108 of the UE 302. At step 34, the SM-DS 310 sends to the MNO back-end system 306 a complete order request message that can include the reference number for the order of the UE 302, a unique identifier for the eSIM 208, e.g., an ICCID value (or an encrypted version thereof) and optionally additional device information. At step 35, the MNO back-end system 306 replies to the SM-DS 310 with a complete order response message.

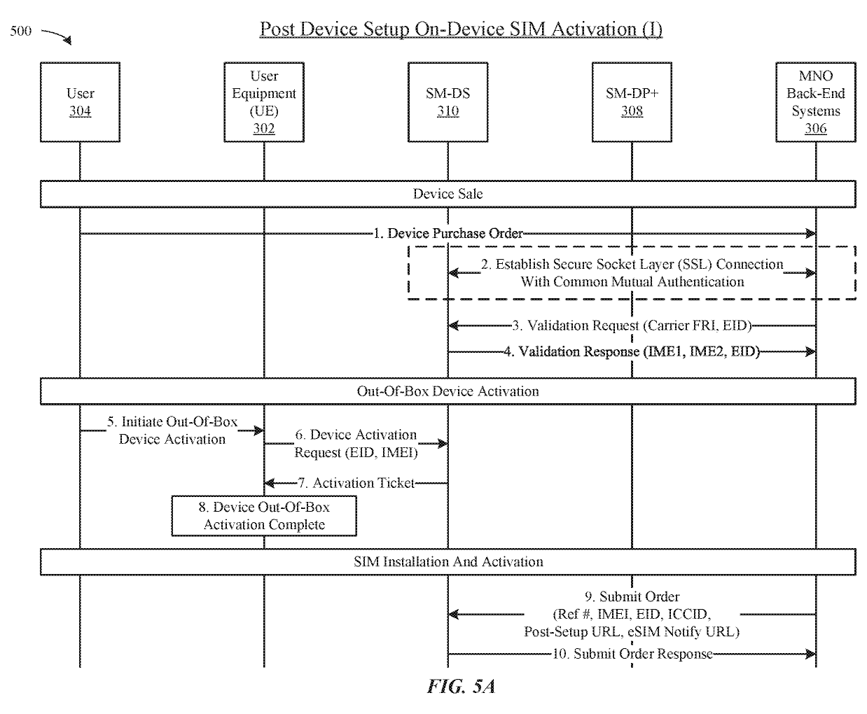

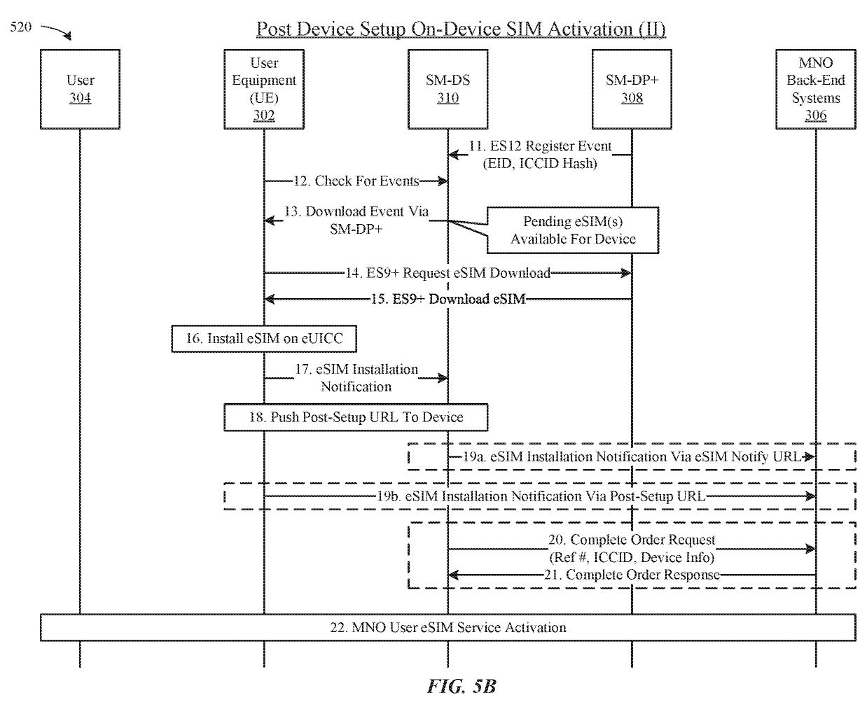

FIGS. 5A and 5B illustrate flow diagrams 500, 520 an example of on-device SIM activation performed after completion of an out-of-box device action process. Unlike the process illustrated in FIGS. 4A, 4B, and 4C, the UE 302 completes a device activation process and subsequently an order for cellular service for the UE 302 occurs. The on-device SIM activation procedure illustrated in FIGS. 5A and 5B can include communication directly between a device services server, e.g., SM-DS 310 and an MNO back-end system 306. In some embodiments, communication between the SM-DS 310 and the MNO back-end system 306 includes one or more API messages defined for assisting with SIM provisioning and on-device SIM activation. At step 1, a user 304 submits a purchase order for the UE 302, e.g., via an online service. At step 2, optionally if not already existent, the SM-DS 310 establishes a secure socket layer (SSL) connection using common mutual authentication with the MNO back-end system 306. At step 3, the MNO back-end system 306 can submit a validation request message to the SM-DS 310 inquiring for information regarding the UE 302, which can be specified by a unique hardware identifier value, e.g., an EID value for an eUICC 108 of the UE 302. At step 4, the SM-DS 310 responds to the MNO back-end system 306 with a validation response message that includes information about the UE 302, such as one or more IMEI values and an EID value.

At step 5, a user 304 initiates an out-of-box device activation procedure to setup the UE 302. At step 6, as part of the out-of-box device activation procedure, the UE 302 sends a device activation request message to a device services server, e.g., to the SM-DS 310, where the request includes one or more unique hardware-based identifier values for the UE 302, e.g., an EID value for the eUICC 108 of the UE 302 and/or an IMEI value for the UE 302. At step 7, the SM-DS 310 responds to the UE 302 with an activation ticket to complete activation of the UE 302. At step 8, the out-of-box activation procedure for the UE 302 completes.

Subsequent to the out-of-box device activation procedure for the UE 302, at step 9, the MNO back-end system 306 sends to the SM-DS 310 a submit order message that specifies an order for configuring cellular wireless service for the UE 302, which can include provisioning, downloading, installing, and activating an eSIM 208 on an eUICC 108 of the UE 302. The submit order message can include: i) information regarding an associated SIM (e.g., an eSIM 208 readied for the UE 302), ii) specific parameter values of the UE 302 and iii) carrier specified network addresses for servers associated with SIM activation for the UE 302. The submit order message can include a reference number value to refer to the order for the UE 302. The submit order message can further include one or more unique hardware-based identifier values for the UE 302, e.g., an IMEI value, an EID value. The submit order message can further include unique values for the eSIM 208, e.g., an ICCID value. The submit order message can include a resolvable network address, e.g., a uniform resource locator (URL) value, for a server with which to perform one or more authentication procedures for activation of the eSIM 208, e.g., a post-setup URL and/or an eSIM notify URL. At step 10, the SM-DS 310 provides a submit order response to the MNO back-end system 306.

Continuing with the flow diagram 520 of FIG. 5B, at step 11, an MNO provisioning server, e.g., the SM-DP+ 308, sends an register event message via an ES12 interface to the SM-DS 310, the register event message including an encrypted version of a unique identifier of the eSIM 208 for the UE 302 and a unique hardware-based identifier of the UE 302, e.g., a hash of the ICCID value of the eSIM 208 and the EID value of the eUICC 108 of the UE 302. The ES12 register event message allows the SM-DS 310 to be made aware of one or more pending eSIMs 208 for the UE 302 from the carrier associated with the MNO back-end system 306. At step 12, the UE 302 sends a message to the SM-DS 310 to determine whether there are pending events queued for the UE 302. At step 13, the SM-DS 310 responds to the query from the UE 302 with an indication of a download event for the UE 302 to obtain one or more pending eSIMs 208 from the SM-DP+ 308. At step 14, the UE 302 establishes a secure connection with the SM-DP+ 308 and requests, via an ES9+ interface, to download the eSIM 208 pending for the UE 302. At step 15, the SM-DP+ 308 downloads to the UE 302 the pending eSIM 208. At step 16, the UE 302 installs the eSIM 208 on the eUICC 108 of the UE 302. At step 17, the UE 302 provides a notification message to the SM-DS 310 of successful installation and activation of the eSIM 208 on the eUICC 108 of the UE 302. At step 18, the SM-DS 310 can push the post-setup URL to the UE 302 to indicate to the UE a network-based carrier server (e.g., an MNO back-end system 306) with which to interact for installation notification and/or activation of the eSIM 208 installed on the eUICC 108 of the UE 302. In some embodiments, the post-setup URL can be provided to the UE 302 earlier by the SM-DS 310, which received the post-setup URL in the submit order message at step 9. For example, the post-setup URL can be provided to the UE 302 in (or with) the response to the check for events, e.g., with the indication to the UE 302 of the availability of one or more pending eSIMs 208 for the UE 302. In some embodiments, optionally at step 19a, the SM-DS 310 provides notification of successful installation of the eSIM 208 to an MNO back-end system 306, e.g., to a network-based server indicated by the eSIM notify URL previously received by the SM-DS 310. In some embodiments, optionally at step 19b, the UE 302 provides directly to an MNO back-end system 306, e.g., to a network-based server indicated by the post-setup URL, notification of successful installation of the eSIM 208 at the UE 302. In some embodiments, optionally at step 20, the SM-DS 310 sends to the MNO back-end system 306 a complete order request message that can include the reference number for the order of the UE 302, a unique identifier for the eSIM 208, e.g., an ICCID value (or an encrypted version thereof) and optionally additional device information. In some embodiments, optionally at step 21, the MNO back-end system 306 replies to the SM-DS 310 with a complete order response message. In some embodiments, the UE 302 provides the eSIM installation notification (or a comparable message) to the MNO back-end system 306 as a form of complete order request message, i.e., sent directly to the MNO back-end system 306 from the UE 302 rather than via the SM-DS 310. At step 22, the UE 302, with assistance from the user 304, can interact with one or more MNO back-end systems, e.g., specified by the post-setup URL provided previously by the SM-DS 310 to the UE 302 to perform necessary actions for eSIM service activation, e.g., user authentication, etc.

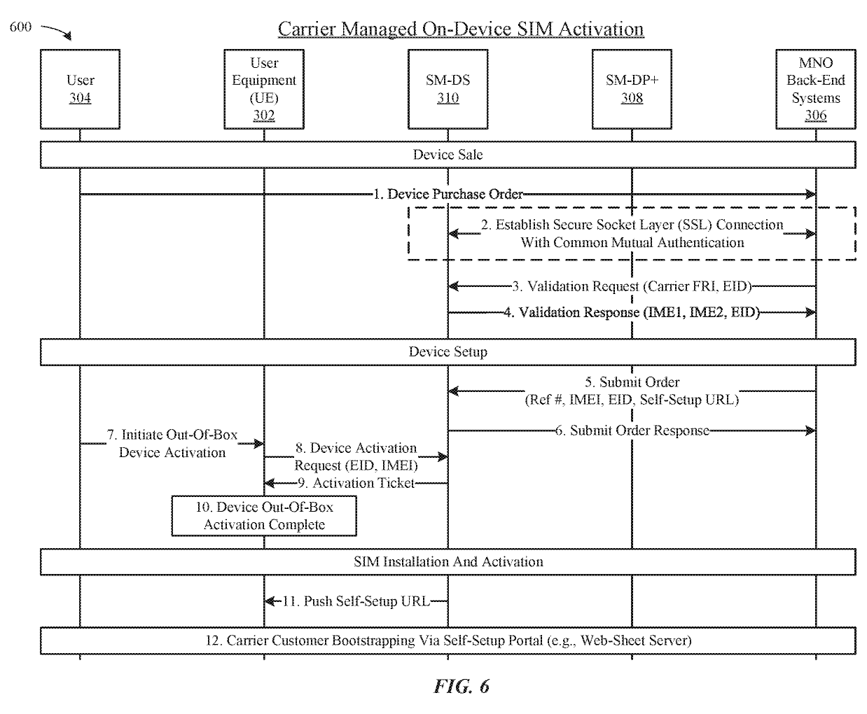

FIG. 6 illustrates a flow diagram 600 of an example of on-device SIM activation performed in association with a carrier-managed process. The on-device SIM activation procedure illustrated in FIG. 6 can include communication directly between a device services server, e.g., SM-DS 310 and an MNO back-end system 306. In some embodiments, communication between the SM-DS 310 and the MNO back-end system 306 includes one or more API messages defined for assisting with SIM provisioning and on-device SIM activation. At step 1, a user 304 submits a purchase order for the UE 302, e.g., via an online service. At step 2, optionally if not already existent, the SM-DS 310 establishes a secure socket layer (SSL) connection using common mutual authentication with the MNO back-end system 306. At step 3, the MNO back-end system 306 can submit a validation request message to the SM-DS 310 inquiring for information regarding the UE 302, which can be specified by a unique hardware identifier value, e.g., an EID value for an eUICC 108 of the UE 302. At step 4, the SM-DS 310 responds to the MNO back-end system 306 with a validation response message that includes information about the UE 302, such as one or more IMEI values and an EID value. At step 5, the MNO back-end system 306 sends to the SM-DS 310 a submit order message that specifies an order for setup of the UE 302, which can include eSIM 208 provisioning, installation, and activation and device configuration for the carrier via a self-setup portal managed by the carrier that provides the cellular wireless service associated with the eSIM 208. The submit order message can include: i) specific parameter values of the UE 302 and ii) carrier specified network addresses for servers associated with SIM activation for the UE 302. The submit order message can include a reference number value to refer to the order for the UE 302. The submit order message can further include one or more unique hardware-based identifier values for the UE 302, e.g., an IMEI value, an EID value. The submit order message can include a resolvable network address, e.g., a uniform resource locator (URL) value, for a self-setup server with which to perform one or more procedures to obtain an eSIM 208 and configuration of the UE 302 for cellular wireless service with a carrier. At step 6, SM-DS 310 provides a submit order response to the MNO back-end system 306.

At step 7, a user 304 initiates an out-of-box device activation procedure to setup the UE 302. At step 8, as part of the out-of-box device activation procedure, the UE 302 sends a device activation request message to a device services server, e.g., to the SM-DS 310, where the request includes one or more unique hardware-based identifier values for the UE 302, e.g., an EID value for the eUICC 108 of the UE 302 and/or an IMEI value for the UE 302. At step 9, the SM-DS 310 responds to the UE 302 with an activation ticket to complete activation of the UE 302. At step 10, the out-of-box activation procedure for the UE 302 completes.

At step 11, the SM-DS 310 pushes the resolvable network address, e.g., the self-setup URL, to the UE 302. At step 12, the user 304 and the UE 302 can interact with the carrier-managed self-setup server, e.g., a web-sheet server, via a self-setup portal to order, obtain, and activate an eSIM 208 for the UE 302.

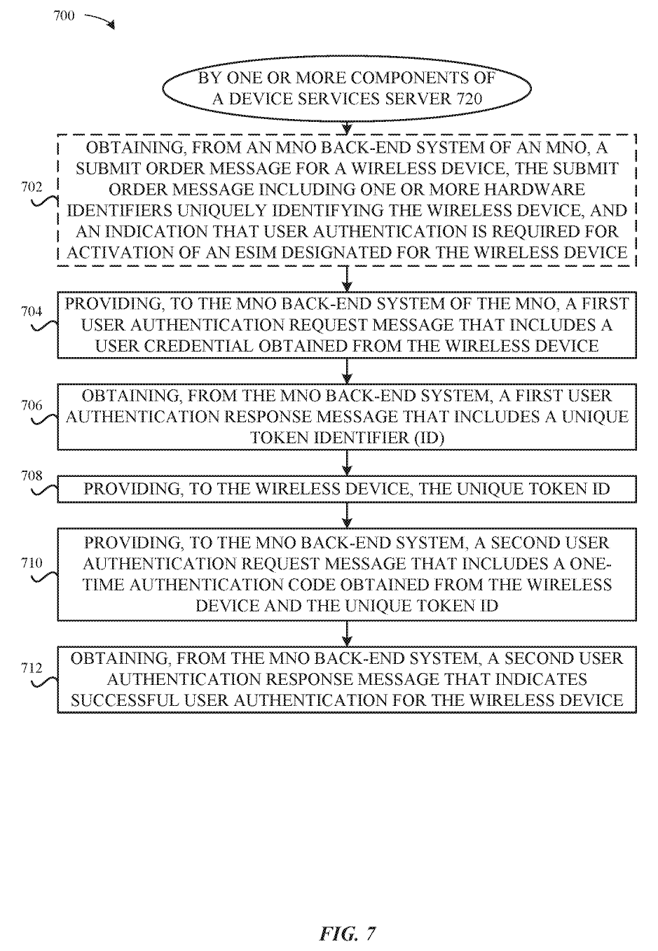

FIG. 7 illustrates a flow chart 700 of an exemplary method to manage on-device SIM activation for a wireless device 102 by one or more components of a device services server 720. In some embodiments, the device services server 720 can include an SM-DS 310. In some embodiments, optionally, at 702, the method includes the device services server 720 obtaining, from an MNO back-end system 306 of an MNO 114, a submit order message for the wireless device 102, where the submit order message includes: i) one or more hardware identifiers uniquely identifying the wireless device 102, and ii) an indication that user authentication is required for activation of an eSIM 208 designated for the wireless device 102. With this information, the device services server 720 can be aware of a requirement for user authentication to allow for activation of an eSIM for the wireless device 102. At 704, the method includes providing, to the MNO back-end system 306 of the MNO 114, a first user authentication request message that includes a user credential obtained from the wireless device 102. At 706, the method further includes obtaining, from the MNO back-end system 306, a first user authentication response message that includes a unique token ID. At 708, the method further includes providing, to the wireless device 102, the unique token ID. At 710, the method further includes providing, to the MNO back-end system 306, a second user authentication request message that includes a one-time authentication code obtained from the wireless device 102 and the unique token ID. At 712, the method further includes obtaining, from the MNO back-end system 306, a second user authentication response message that indicates successful user authentication for the wireless device 102.

In some embodiments, the method further includes obtaining, from the wireless device 102, a request to initiate user authentication for the wireless device 102, the request including the user credential. In some embodiments, the one-time authentication code is provided to a second wireless device by the MNO back-end system 306 responsive to receipt of the first user authentication request message from the device services server. In some embodiments, the second wireless device and the wireless device 102 are associated with a common cellular services user account of the MNO 114. In some embodiments, the submit order message from MNO back-end system 306 includes a unique MNO reference value associated with activation of the eSIM 208 for the wireless device 102, and the first and second user authentication request messages provided to the MNO back-end system 306 each include the unique MNO reference value. In some embodiments, the method further includes receiving, from an MNO provisioning server, a register event message including an encrypted version of an identifier for the eSIM 208 to be installed and activated on a secure element of the wireless device 102. In some embodiments, the encrypted version of the identifier for the eSIM includes a hash of an ICCID value for the eSIM 208. In some embodiments, the register event message further includes a unique identifier for the secure element of the wireless device. In some embodiments, the unique identifier for the secure element includes an EID value for the eUICC 108 of the wireless device 102. In some embodiments, the method further includes responsive to receipt from the wireless device 102 of a notification indicating installation of the eSIM 208 on a secure element of the wireless device 102, sending to the MNO back-end system 306 a complete order request message indicating successful installation of the eSIM 208 at the wireless device 102. In some embodiments, the complete order request message further indicates to the MNO back-end system 306 to activate a subscription for the eSIM 208 of the wireless device 102 to access a wireless network of the MNO 114. In some embodiments, the method further includes: i) receiving, from the wireless device 102, a request for device activation, the request including at least one of the one or more hardware identifiers uniquely identifying the wireless device 102, and ii) determining the wireless device 102 will perform on-device activation of the eSIM 208.

In some embodiments, a method to manage on-device SIM activation for a wireless device 102 by a device services server, such as an SM-DS 310, includes: i) obtaining, from an MNO back-end system 306 of an MNO 114, a submit order message for the wireless device 102, the submit order message including: one or more hardware identifiers uniquely identifying the wireless device, and one or more network addresses for activation of an eSIM 208 designated for the wireless device 102; and ii) providing, to the wireless device 102, an indication of availability of the eSIM 208 designated for the wireless device 102, where confirmation of installation of the eSIM 208 at the wireless device 102 is communicated to the MNO back-end system 306 via at least one of the one or more network addresses. In some embodiments, the one or more network addresses include an eSIM notify URL, and the method further includes the device services server providing, to the MNO back-end system 306 via the eSIM notify URL, an indication of installation of the eSIM 208 at the wireless device 102. In some embodiments, the one or more network addresses include a post-setup URL, and the method further includes providing, to the wireless device 102 the post-setup URL, via which the wireless device 102 provides, to the MNO back-end system 306, indication of installation of the eSIM 208 at the wireless device 102.

In some embodiments, a method to manage on-device SIM activation for a wireless device 102 by a device services server, such as an SM-DS 310, includes: i) obtaining, from an MNO back-end system 306 of an MNO 114, a submit order message for the wireless device 102, the submit order message including: one or more hardware identifiers uniquely identifying the wireless device 102, and a network address for activation of an eSIM 208 designated for the wireless device 102; and ii) providing, to the wireless device 102, the network address at which the wireless device performs a procedure to activate the eSIM 208. In some embodiments, the network address includes a self-setup URL for a web-sheet server of the MNO 114 with which the wireless device 102 activates the eSIM 208.

### Representative Exemplary Apparatus

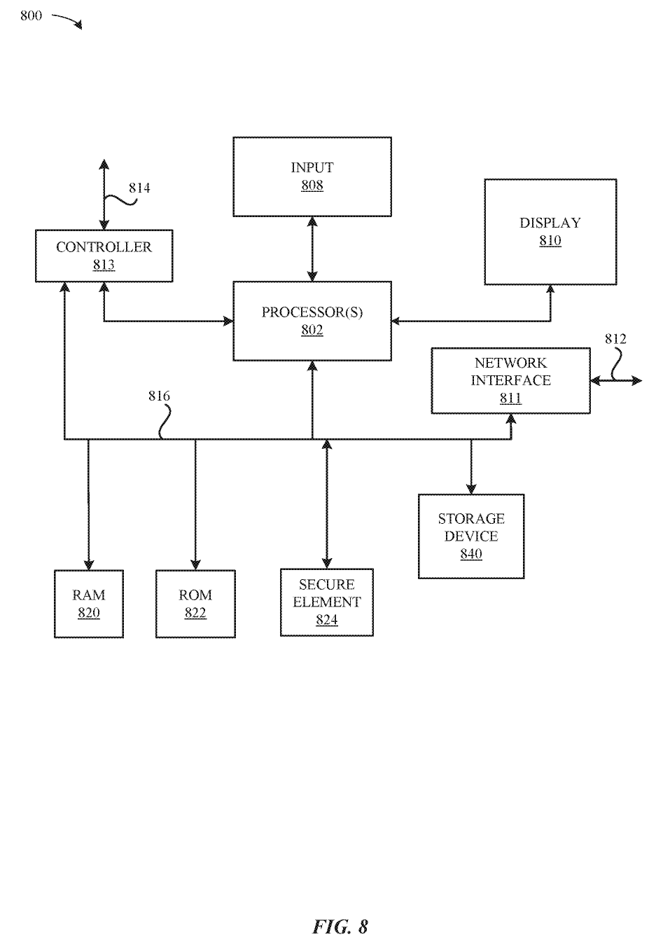

FIG. 8 illustrates in block diagram format an exemplary computing device 800 that can be used to implement the various components and techniques described herein, according to some embodiments. In particular, the detailed view of the exemplary computing device 800 illustrates various components that can be included in a UE 302 or a wireless device 102. As shown in FIG. 8, the computing device 800 can include one or more processors 802 that represent microprocessors or controllers for controlling the overall operation of computing device 800. In some embodiments, the computing device 800 can also include a user input device 808 that allows a user of the computing device 800 to interact with the computing device 800. For example, in some embodiments, the user input device 808 can take a variety of forms, such as a button, keypad, dial, touch screen, audio input interface, visual/image capture input interface, input in the form of sensor data, etc. In some embodiments, the computing device 800 can include a display 810 (screen display) that can be controlled by the processor(s) 802 to display information to the user (for example, information relating to incoming, outgoing, or active communication sessions). A data bus 816 can facilitate data transfer between at least a storage device 840, the processor(s) 802, and a controller 813. The controller 813 can be used to interface with and control different equipment through an equipment control bus 814. The computing device 800 can also include a network/bus interface 811 that couples to a data link 812. In the case of a wireless connection, the network/bus interface 811 can include wireless circuitry, such as a wireless transceiver and/or baseband component. The computing device 800 can also include a secure element 824, which can be configured to store one or more SIM profiles and/or eSIM profiles 208. The secure element 824 can include an eUICC 108, an iUICC, and/or one or more UICCs 118.

The computing device 800 also includes a storage device 840, which can include a single storage or a plurality of storages (e.g., hard drives and/or solid-state drives), and includes a storage management module that manages one or more partitions within the storage device 840. In some embodiments, storage device 840 can include flash memory, semiconductor (solid state) memory or the like. The computing device 800 can also include a Random-Access Memory (RAM) 820 and a Read-Only Memory (ROM) 822. The ROM 822 can store programs, utilities or processes to be executed in a non-volatile manner. The RAM 820 can provide volatile data storage, and stores instructions related to the operation of the computing device 800.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to manage on-device subscriber identity module (SIM) activation for a wireless device by a device services server, the method comprising:
providing, to a mobile network operator (MNO) back-end system of an MNO, a first user authentication request message that includes a user credential obtained from the wireless device;
obtaining, from the MNO back-end system, a first user authentication response message that includes a unique token identifier (ID);
providing, to the wireless device, the unique token ID;
providing, to the MNO back-end system, a second user authentication request message that includes a one-time authentication code obtained from the wireless device and the unique token ID; and
obtaining, from the MNO back-end system, a second user authentication response message that indicates successful user authentication for the wireless device.

2. The method of claim 1, further comprising:
obtaining, from the MNO back-end system, a submit order message for the wireless device, the submit order message including:
one or more hardware identifiers uniquely identifying the wireless device; and
an indication that user authentication is required for activation of an electronic SIM (eSIM) designated for the wireless device.

3. The method of claim 2, wherein:
the submit order message from MNO back-end system includes a unique MNO reference value associated with activation of the eSIM for the wireless device; and
the first and second user authentication request messages provided to the MNO back-end system each include the unique MNO reference value.

4. The method of claim 2, further comprising:
receiving, from the wireless device, a request for device activation, the request including at least one of the one or more hardware identifiers uniquely identifying the wireless device; and
determining the wireless device will perform on-device activation of the eSIM.

5. The method of claim 1, further comprising:
obtaining, from the wireless device, a request to initiate user authentication for the wireless device, the request including the user credential.

6. The method of claim 1, wherein the one-time authentication code is provided to a second wireless device by the MNO back-end system responsive to receipt of the first user authentication request message from the device services server.

7. The method of claim 6, wherein the second wireless device and the wireless device are associated with a common cellular services user account of the MNO.

8. The method of claim 1, further comprising:
receiving, from an MNO provisioning server, a register event message including an encrypted version of an identifier for an eSIM to be installed and activated on a secure element of the wireless device.

9. The method of claim 8, wherein the encrypted version of the identifier for the eSIM comprises a hash of an integrated circuit card identifier (ICCID) value for the eSIM.

10. The method of claim 8, wherein the register event message further includes a unique identifier for the secure element of the wireless device.

11. The method of claim 10, wherein the unique identifier for the secure element comprises an embedded universal integrated circuit card (eUICC) identifier (EID) value for an eUICC of the wireless device.

12. The method of claim 1, further comprising:
responsive to receipt from the wireless device of a notification indicating installation of an eSIM on a secure element of the wireless device, sending to the MNO back-end system a complete order request message indicating successful installation of the eSIM at the wireless device.

13. The method of claim 12, wherein the complete order request message further indicates to the MNO back-end system to activate a subscription for the eSIM of the wireless device to access a wireless network of the MNO.

14. A method to manage on-device subscriber identity module (SIM) activation for a wireless device by a device services server, the method comprising:
obtaining, from a mobile network operator (MNO) back-end system of an MNO, a submit order message for the wireless device, the submit order message including:
one or more hardware identifiers uniquely identifying the wireless device; and
one or more network addresses for activation of an electronic SIM (eSIM) designated for the wireless device; and
providing, to the wireless device, an indication of availability of the eSIM designated for the wireless device,
wherein confirmation of installation of the eSIM at the wireless device is communicated to the MNO back-end system via at least one of the one or more network addresses.

15. The method of claim 14, wherein:
the one or more network addresses include an eSIM notify universal record locator (URL); and
the method further includes providing, to the MNO back-end system via the eSIM notify URL, an indication of installation of the eSIM at the wireless device.

16. The method of claim 14, wherein:
the one or more network addresses include a post-setup universal record locator (URL); and
the method further includes providing, to the wireless device the post-setup URL, via which the wireless device provides, to the MNO back-end system, indication of installation of the eSIM at the wireless device.

17. An apparatus comprising one or more processors coupled to a memory storing instructions to configure a device services server to manage on-device subscriber identity module (SIM) activation for a wireless device, the one or more processors configured to:
provide, to a mobile network operator (MNO) back-end system of an MNO, a first user authentication request message that includes a user credential obtained from the wireless device;
obtain, from the MNO back-end system, a first user authentication response message that includes a unique token identifier (ID);
provide, to the wireless device, the unique token ID;
provide, to the MNO back-end system, a second user authentication request message that includes a one-time authentication code obtained from the wireless device and the unique token ID; and
obtain, from the MNO back-end system, a second user authentication response message that indicates successful user authentication for the wireless device.

18. The apparatus of claim 17, wherein the one or more processors are further configured to:
obtain, from the MNO back-end system, a submit order message for the wireless device, the submit order message including:
one or more hardware identifiers uniquely identifying the wireless device; and
an indication that user authentication is required for activation of an electronic SIM (eSIM) designated for the wireless device.

19. The apparatus of claim 18, wherein:
the submit order message from MNO back-end system includes a unique MNO reference value associated with activation of the eSIM for the wireless device; and
the first and second user authentication request messages provided to the MNO back-end system each include the unique MNO reference value.

20. The apparatus of claim 18, wherein the one or more processors are further configured to:
receive, from the wireless device, a request for device activation, the request including at least one of the one or more hardware identifiers uniquely identifying the wireless device; and
determine the wireless device will perform on-device activation of the eSIM.
